(19) United States
(12) Patent Application Publication
(10) Pub. No.: US 2025/0292364 A1
(43) Pub. Date: Sep. 18, 2025

(54) BI-DIRECTION SUB-FILTER DESIGN FOR IMAGE PROCESSING

(71) Applicant: QUALCOMM Incorporated, San Diego, CA (US)

(72) Inventors: Yufei Zhao, Cupertino, CA (US); Vinod Kumar Nahval, Mountain House, CA (US)

(21) Appl. No.: 18/602,724

(22) Filed: Mar. 12, 2024

(51) Int. Cl. G06T 5/20

(52) U.S. Cl. CPC G06T 5/20

(57) ABSTRACT

A device may determine a plurality of filtered values for a plurality of sub-kernels of a kernel of image data, the filtered values corresponding to performing an image filtering operation on each of the plurality of sub-kernels, including using one or more filtered values for one or more sub-kernels of a neighboring kernel as a first one or more filtered values for a first one or more sub-kernels of the kernel and performing the image filtering operation on each of a second one or more sub-kernels of the kernel to generate a second one or more filtered values for the second one or more sub-kernels of the kernel. The device may determine, using the plurality of filtered values, a filtered value for the kernel that corresponds to performing the image filtering operation on the kernel.

### TECHNICAL FIELD

This disclosure relates to image processing.

### BACKGROUND

A digital camera includes an image sensor that captures image frames. The digital camera also includes a camera processor that perform various image processing operations on the captured image frames to enhance image quality, adapt to different shooting conditions, provide user-desired effects, and the like.

### SUMMARY

In general, this disclosure describes techniques for performing image filtering operations on an image frame. Instead of directly performing an image filtering operation on a kernel of an image frame, this disclosure describes techniques for dividing a kernel into multiple sub-kernels, performing the image filtering operation on each sub-kernel, and assembling the results of performing the image filtering operation on the sub-kernels of the kernel to calculate the result of performing the image filtering operation on the entire kernel.

An image filtering operation may be an operation performed on pixels of an image to generate one or more filtered values. An image filtering operation may be a neighborhood filtering operation that is applied on a group of pixels to generate a filtered value. For example, an image filtering operation maybe applied to pixels in a kernel (e.g., a block of pixels) of an image to generate a filtered value, which may be a new pixel value that replaces the pixel value of the central pixel in the kernel. Examples of image filtering operations include a sum of absolute differences (SAD) filter, a maximum filter, a minimum filter, a median filter, a green map (GMAP) filter, and the like.

To perform image processing on an image, a processor may determine a pixel size of kernels of the image, such as 7×7, 8×8, 9×9, etc., and may perform an image filtering operation on kernels of the image. In the example of a 7×7 kernel, the processor may perform an image filtering operation on every 7×7 block of pixels of the image. However, it may be computationally expensive to performing an image filtering operation by directly calculating a filtered value from an entire kernel of pixels.

In accordance with aspects of this disclosure, instead of performing an image filtering operation on a kernel of an image, a processor may instead perform the image filtering operation on sub-kernels of the kernel to generate filtered values for the sub-kernels. The processor may then use the generated filtered values to determine a filtered value for the kernel that corresponds to performing the image filtering operation on the kernel. By performing image filtering operations on sub-kernels of a kernel, the processor may calculate a filtered value of a sub-kernel from many fewer pixels at a time compared with directly calculating a filtered value of a kernel from all of the pixels of the kernel. Filtering image using sub-kernels may reduce the power consumption of the processor to determine the filtered value for the kernel.

When the processor processes a kernel that is a neighboring kernel to a previously processed kernel having sub-kernels for which the processor has already calculated filtered values, some of the sub-kernels of the kernel may overlap (i.e., cover the same pixels in the image) sub-kernels of the previously processed kernel. Instead of calculating the filtered values for those sub-kernels of the kernel, the processor may use, as the filtered values for those sub-kernels, the already-calculated filtered values of sub-kernels of the previously processed kernel that overlap those sub-kernels of the kernel. In this way, the example techniques may reduce the number of operations performed by the processor to perform image filtering operations on kernels of an image.

In some aspects, the techniques described herein relate to a computing device for image processing, the computing device including: a memory; and one or more processors implemented in circuitry, coupled to the memory, and configured to: determine a plurality of filtered values for a plurality of sub-kernels of a kernel of image data, the plurality of values corresponding to performing an image filtering operation on each of the plurality of sub-kernels, including: using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing the image filtering operation on each of a second one or more sub-kernels of the kernel to generate a second one or more filtered values for the second one or more sub-kernels of the kernel; and determine, using the plurality of filtered values, a filtered value for the kernel that corresponds to performing the image filtering operation on the kernel.

In some aspects, the techniques described herein relate to a method of image processing, the method including: determining, with one or more processors, a plurality of filtered values for a plurality of sub-kernels of a kernel of image data, the plurality of values corresponding to performing an image filtering operation on each of the plurality of sub-kernels, including: using, with the one or more processors, one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing, with the one or more processors, the image filtering operation on each of a second one or more sub-kernels of the kernel to generate a second one or more filtered values for the second one or more sub-kernels of the kernel; and determining, with the one or more processors and using the plurality of filtered values, a filtered value for the kernel that corresponds to performing the image filtering operation on the kernel.

In some aspects, the techniques described herein relate to an apparatus for image processing, the apparatus including: means for determining a plurality of filtered values for a plurality of sub-kernels of a kernel of image data, the plurality of values corresponding to performing an image filtering operation on each of the plurality of sub-kernels, including: means for using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and means for performing the image filtering operation on each of a second one or more sub-kernels of the kernel to generate a second one or more filtered values for the second one or more sub-kernels of the kernel; and means for determining, using the plurality of filtered values, a filtered value for the kernel that corresponds to performing the image filtering operation on the kernel.

In some aspects, the techniques described herein relate to a computer-readable storage medium storing instructions thereon that when executed cause one or more processors to: determine a plurality of filtered values for a plurality of sub-kernels of a kernel of image data, the plurality of values corresponding to performing an image filtering operation on each of the plurality of sub-kernels, including: using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing the image filtering operation on each of a second one or more sub-kernels of the kernel to generate a second one or more filtered values for the second one or more sub-kernels of the kernel; and determine, using the plurality of filtered values, a filtered value for the kernel that corresponds to performing the image filtering operation on the kernel.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform image filtering operations according to the techniques of this disclosure.

FIGS. 2A-2E are conceptual diagrams illustrating example techniques for performing image filtering operations on kernels of image data.

FIG. 3 illustrates a timing diagram that compares applying a filter to a kernel of image data to applying the filter to sub-kernels of the kernel.

FIG. 4 is a block diagram illustrating a camera processor that takes advantage of horizontal neighboring kernels to reduce computation of sub-kernel filtered values, in accordance with aspects of this disclosure.

FIG. 5 is a block diagram illustrating a camera processor that takes advantage of horizontal and vertical neighboring kernels to reduce computation of sub-kernel filtered values, in accordance with aspects of this disclosure.

FIG. 6 is a flowchart showing an example method of operation according to the techniques of this disclosure.

### DETAILED DESCRIPTION

In general, this disclosure describes techniques for performing image filtering operations on an image frame in ways that reduces the amount of computations that is performed. Instead of directly performing an image filtering operation on a kernel of an image frame, this disclosure describes techniques for dividing a kernel into multiple sub-kernels, performing the image filtering operation on each sub-kernel, and assembling the results of performing the image filtering operation on the sub-kernels of the kernel to calculate the result of performing the image filtering operation on the entire kernel.

An image filtering operation may be an operation performed on pixels of an image to generate one or more filtered values. An image filtering operation may be a neighborhood filtering operation that is applied on a group of pixels to generate a filtered value. For example, an image filtering operation maybe applied to pixels in a kernel (e.g., a block of pixels) of an image to generate a filtered value, which may be a new pixel value that replaces the pixel value of the central pixel in the kernel. Examples of image filtering operations include a sum of absolute differences (SAD) filter, a maximum filter, a minimum filter, a median filter, a green map (GMAP) filter, and the like.

A processor may perform an image filtering operation on kernels of the image. In the example of a 7×7 kernel, the processor may perform an image filtering operation on every 7×7 block of pixels of the image. However, it may be computationally expensive to performing an image filtering operation by directly calculating a filtered value from an entire kernel of pixels.

In accordance with aspects of this disclosure, instead of performing an image filtering operation on a kernel of an image, a processor may instead perform the image filtering operation on sub-kernels of the kernel to generate filtered values for the sub-kernels. The processor may then use the generated filtered values to determine a filtered value for the kernel that corresponds to performing the image filtering operation on the kernel. By performing image filtering operations on sub-kernels of a kernel, the processor may calculate a filtered value of a sub-kernel from many fewer pixels at a time compared with directly calculating a filtered value of a kernel from all of the pixels of the kernel. Filtering image using sub-kernels may reduce the power consumption of the processor to determine the filtered value for the kernel because the process may filter much smaller blocks of pixels compared with directly calculating a filtered value from an entire kernel of pixels.

Further, when the processor processes a kernel that is a neighboring kernel to a previously processed kernel having sub-kernels for which the processor has already calculated filtered values, some of the sub-kernels of the kernel may overlap (i.e., cover the same pixels in the image) sub-kernels of the previously processed kernel. Because performing the same image filtering operation on the same block of pixels will produce the same filtered value, the processor may refrain from performing image filtering operations on sub-kernels of a current kernel that overlap corresponding sub-kernels of a previously encountered kernel. Instead of calculating the filtered values for those sub-kernels of the current kernel that overlap sub-kernels of the previously processed kernel, the processor may use, as the filtered values for those sub-kernels, the already-calculated filtered values of sub-kernels of the previously processed kernel that overlap those sub-kernels of the kernel.

By using the already-calculated filtered values of sub-kernels of neighboring kernels as the filtered values for sub-kernels of a current kernel, the processor does not have to perform the actual image filtering operation on those sub-kernels of the kernel. In this way, the example techniques may reduce the number of operations performed by the processor to perform image filtering operations on kernels of an image.

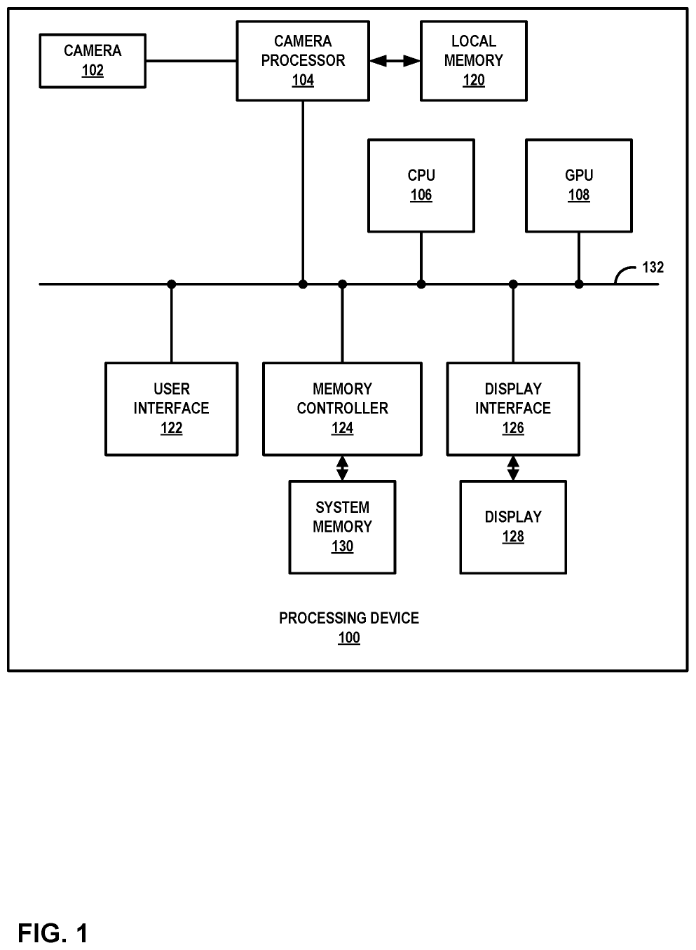

FIG. 1 is a block diagram of a device configured to perform image filtering operations according to the techniques of this disclosure. Examples of processing device 100 include processing systems in an automobile (e.g., an advance driver assistance system (ADAS)), processing systems in a robotics application, AR headsets, virtual reality (VR) headsets, stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

As illustrated in the example of FIG. 1, processing device 100 includes camera 102 (e.g., having a lens, a filter, and an image sensor), camera processor 104 and local memory 120 of camera processor 104, a central processing unit (CPU) 106, a graphical processing unit (GPU) 108, user interface 122, memory controller 124 that provides access to system memory 130, and display interface 126 that outputs signals that cause graphical data to be displayed on display 128. Although the example of FIG. 1 illustrates processing device 100 including one camera 102, in some examples, processing device 100 may include a plurality of cameras 102, such as for omnidirectional image or video capture. Also, although processing device 100 is illustrated as including one camera processor 104, in some examples, there may be a plurality of camera processors (e.g., one for each of cameras 102) or one camera processor for each of one or more cameras 102.

Also, although the various components are illustrated as separate components, in some examples the components may be combined to form a system on chip (SoC). As an example, camera processor 104, CPU 106, GPU 108, and display interface 126 may be formed on a common integrated circuit (IC) chip. In some examples, one or more of camera processor 104, CPU 106, GPU 108, and display interface 126 may be in separate IC chips. Additional examples of components that may be configured to perform the example techniques include a digital signal processor (DSP). Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 120 and system memory 130 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 132. Bus 132 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera processor 104 is configured to receive image frames from camera 102, and process the image frames to generate output frames for display. CPU 106, GPU 108, camera processor 104, or some other circuitry may be configured to process the output frame that includes image content generated by camera processor 104 into images for display on display 128. In some examples, GPU 108 may be further configured to render graphics content on display 128.

In some examples, camera processor 104 may be configured as an image processing pipeline. For instance, camera processor 104 may include a camera interface that interfaces between camera 102 and camera processor 104. Camera processor 104 may include additional circuitry to process the image content. Camera processor 104 outputs the resulting frames with image content (e.g., pixel values for each of the image pixels) to system memory 130 via memory controller 124.

CPU 106 may comprise a general-purpose or a special-purpose processor that controls operation of processing device 100. A user may provide input to processing device 100 to cause CPU 106 to execute one or more software applications. The software applications that execute on CPU 106 may include, for example, a media player application, a video game application, a graphical user interface application or another program. The user may provide input to processing device 100 via one or more input devices (not shown) such as a keyboard, a mouse, a microphone, a touch pad or another input device that is coupled to processing device 100 via user interface 122.

Memory controller 124 facilitates the transfer of data going into and out of system memory 130. For example, memory controller 124 may receive memory read and write commands, and service such commands with respect to system memory 130 in order to provide memory services for the components in processing device 100. Memory controller 124 is communicatively coupled to system memory 130. Although memory controller 124 is illustrated in the example of processing device 100 of FIG. 1 as being a processing circuit that is separate from both CPU 106 and system memory 130, in other examples, some or all of the functionality of memory controller 124 may be implemented on one or both of CPU 106 and system memory 130.

System memory 130 may store program modules and/or instructions and/or data that are accessible by camera processor 104, CPU 106, and GPU 108. For example, system memory 130 may store user applications, resulting frames from camera processor 104, etc. System memory 130 may additionally store information for use by and/or generated by other components of processing device 100. For example, system memory 130 may act as a device memory for camera processor 104.

Camera processor 104 may perform image filtering operations on image frames to enhance image quality, adapt to different shooting conditions, provide user-desired effects, and the like. Such image frames may be image frames that camera processor 104 receives from camera 102 and/or image frames stored in memory (e.g., system memory 130).

An image filtering operation may be an operation performed on pixels of an image frame to generate one or more filtered values. An image filtering operation may be a neighborhood filtering operation that is applied to a group of pixels to generate a filtered value. For example, an image filtering operation may be applied to pixels in a kernel (e.g., a block of pixels) of an image to generate a filtered value, which may be a new pixel value that replaces the pixel value of the central pixel in the kernel. Examples of image filtering operations include a sum of absolute differences (SAD) filter, a maximum filter, a minimum filter, a median filter, a green map (GMAP) filter, and the like.

Camera processor 104 may perform an image filtering operation on an image frame by applying the image filtering operation on each of a plurality of kernels of the image frame. In the example of a 7×7 kernel, camera processor 104 may perform an image filtering operation on every 7×7 block of pixels of the image. However, it may be computationally expensive for camera processor 104 to perform an image filtering operation on a kernel by directly calculating a filtered value from an entire kernel of pixels. For example, perform an image filtering operation on a 7×7 kernel, camera processor 104 may have to process all 49 pixels of the kernel at a time to perform the image filtering operation on the kernel. Further, in order to perform the image filtering operation on each of the plurality of kernels of the image frame, camera processor 104 may also have to repeatedly process all 49 pixels of each kernel, which may increase the power consumption and the computation workload of camera processor 104.

In accordance with aspects of this disclosure, instead of performing an image filtering operation directly on all of the pixels of a kernel of an image, camera processor 104 may perform the image filtering operation on sub-kernels of the kernel to generate filtered values for the sub-kernels. Camera processor 104 may use the filtered values for the sub-kernels to determine a filtered value for the kernel that corresponds to performing the image filtering operation on the kernel. By performing image filtering operations on sub-kernels of a kernel, the processor may calculate a filtered value of a sub-kernel from many fewer pixels at a time compared with directly calculating a filtered value of a kernel from all of the pixels of the kernel, which may reduce the power consumption of the processor to determine the filtered value for the kernel that corresponds to performing the image filtering operation on the kernel.

Sub-kernels of a kernel may be blocks of pixels within the kernel that are each of a smaller pixel size than that of the kernel. For example, a kernel having a pixel size of 7×7 pixels may have sub-kernels each having a pixel size of 5×5 pixels. Given sub-kernels of a specific pixel size, a kernel may have sub-kernels that cover every block of the specified pixel size within the kernel. For example, a 7×7 kernel may have nine 5×5 sub-kernels to cover every 5×5 block of pixels within the 7×7 kernel. Thus, instead of performing an image filtering operation directly on all 49 pixels of a 7×7 kernel to determine a filtered value for the kernel, camera processor 104 may perform the image filtering operation on each of the nine 5×5 sub-kernels of the kernel to generate a filtered value for each of the nine sub-kernels of the kernel.

Camera processor 104 may use the filtered values for the sub-kernels to determine a filtered value for the kernel that corresponds to performing the image filtering operation on the kernel. That is, camera processor 104 may generate, from the filtered values for the sub-kernels, the same filtered value for the kernel as the filtered value for the kernel resulting from performing the image filtering operation directly on all of the pixels of the kernel. Camera processor 104 may therefore replace the pixel value of the center pixel of the kernel with the determined filtered value for the kernel.

For example, instead of performing a maximum filter operation on all of the pixels of a 7×7 kernel, camera processor 104 may perform the maximum filter operation on each of the nine 5×5 sub-kernels to generate nine filtered values. Camera processor 104 may therefore determine the largest filtered value out of the nine filtered values as the filtered value for the kernel. In this way camera processor 104 may determine a filtered value for the kernel that is the same filtered value as would have resulted from performing the maximum filter operation directly on the kernel.

In another example, instead of performing a minimum filter operation on all of the pixels of a 7×7 kernel, camera processor 104 may perform the minimum filter operation on each of the nine 5×5 sub-kernels to generate nine filtered values. Camera processor 104 may therefore determine the lowest filtered value out of the nine filtered values as the filtered value for the kernel. In this way camera processor 104 may determine a filtered value for the kernel that is the same filtered value as would have resulted from performing the minimum filter operation directly on the kernel.

Camera processor 104 may determine filtered values for a plurality of kernels within an image frame to update or replace a plurality of pixel values in the image frame. For example, in addition to determining a filtered value for a first kernel to replace the pixel value of the center pixel in the first kernel, to replace a horizontally adjacent pixel to the immediate right in the image frame, camera processor 104 may also determine a filtered value for a second kernel having a center pixel to the immediate right of the center pixel of the first kernel. Similarly, to replace a vertically adjacent pixel below the center pixel in the first kernel, camera processor 104 may also determine a filtered value for a third kernel having a center pixel that is vertically adjacent to and below the center pixel of the first kernel.

In these examples, the second kernel is shifted to the right in the image frame by one pixel compared to the first kernel, and therefore the first kernel and the second kernel are horizontal neighboring kernels with respect to each other. Similarly, the third kernel is shifted downwards in the image frame by one pixel compared to the first kernel, and therefore the first kernel and the third kernel are vertical neighboring kernels with respect to each other.

Neighboring kernels of an image frame may partially overlap each other. In the case of two horizontal neighboring 7×7 kernels, the right six columns of pixels of a left neighboring kernel may overlap the left six columns of pixels of a right neighboring kernel. Similarly, in the case of two vertical neighboring 7×7 kernels, six rows of pixels of a top neighboring kernel may overlap six rows of pixels of a bottom neighboring kernel. Thus, in the examples where the neighboring 7×7 kernels have 5×5 sub-kernels, six sub-kernels of each of two neighboring kernels may overlap each other. That is, six sub-kernels of a first neighboring kernel may cover the same pixels of the image frame as six sub-kernels of a second neighboring kernel.

When camera processor 104 determines the filtered value of a kernel by determining filtered values for sub-kernels of the kernel, camera processor 104 may have already determined filtered values of sub-kernels of a neighboring kernel that cover the same pixels of the image frame as some of the sub-kernels of the kernel. Instead of calculating the filtered values for sub-kernels of a kernel that cover the same pixels of an image frame as sub-kernels of a previously encountered neighboring kernel, camera processor 104 may use, as the filtered values for those sub-kernels of the kernel, the already-calculated filtered values of sub-kernels of the previously encountered kernel that overlap those sub-kernels of the kernel. That is, camera processor 104 may determine the filtered values for those sub-kernels of the kernel to be the already-calculated filtered values of sub-kernels of the previously encountered kernel that overlap those sub-kernels of the kernel

Camera processor 104 may perform the image filtering operation on the remaining sub-kernels of the kernel that do not cover the same pixels of the image frame as any of the sub-kernels of the previously encountered kernel. Camera processor 104 may therefore determine, using the filtered values of the sub-kernels of the kernel, a filtered value for the kernel that corresponds to performing the image filtering operation on the kernel. In this way, the example techniques may reduce the number of operations performed by camera processor 104 to perform image filtering operations on kernels of an image.

In the example of neighboring 7×7 kernels have 5×5 sub-kernels, six sub-kernels of each of two neighboring kernels may overlap each other. As such, camera processor 104 may use filtered values of six sub-kernels of a neighboring kernel as the filtered values for six sub-kernels of a current kernel, in lieu of performing the image filtering operation to the six sub-kernels of the current kernel to generate filtered values for those six sub-kernels. Camera processor 104 may therefore only have to perform the image filtering operation on three of the nine sub-kernels of the current kernel, thereby reducing the amount of processing that is required to perform the image filtering operation on the current kernel.

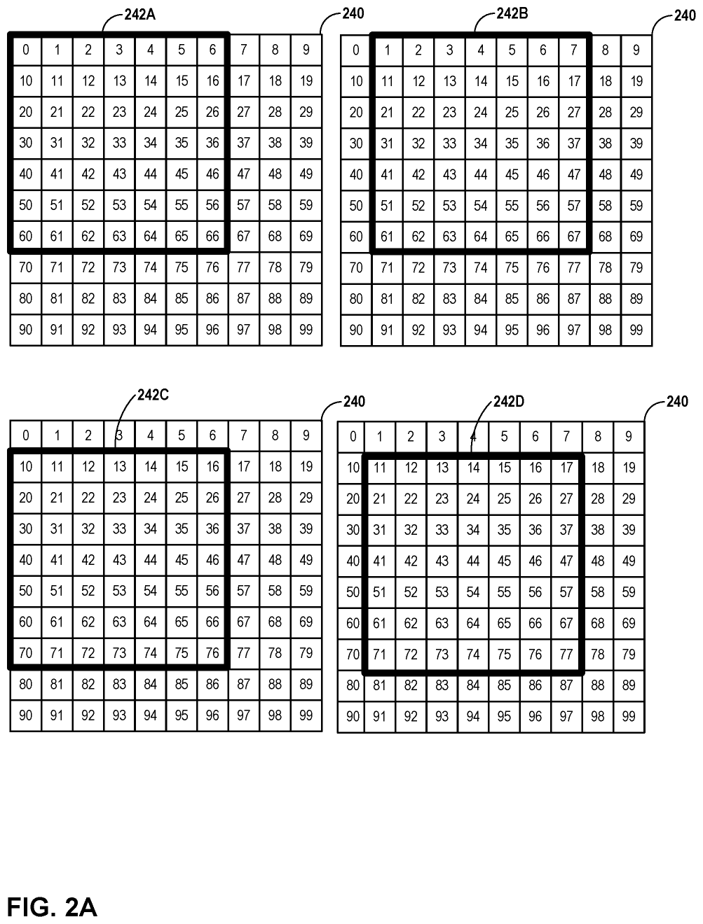

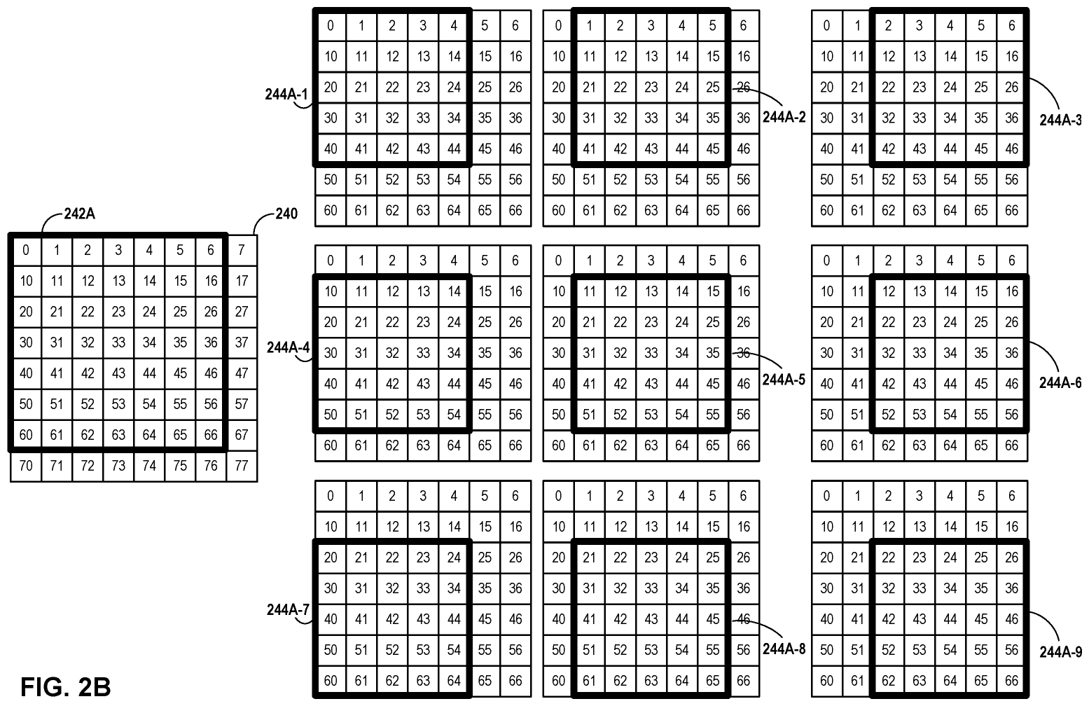

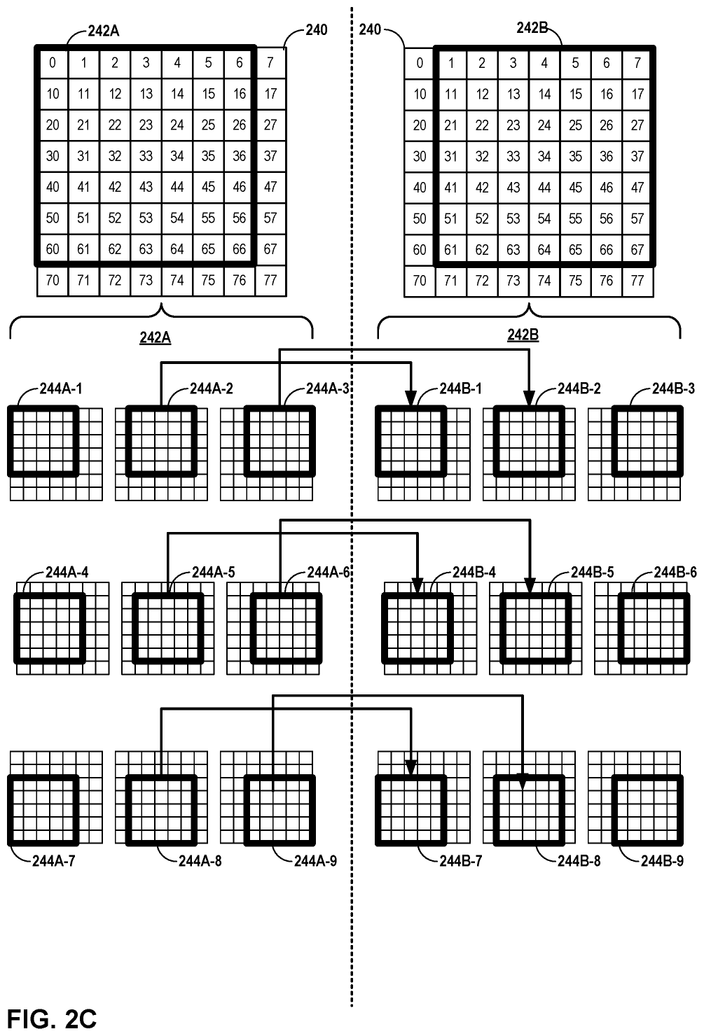

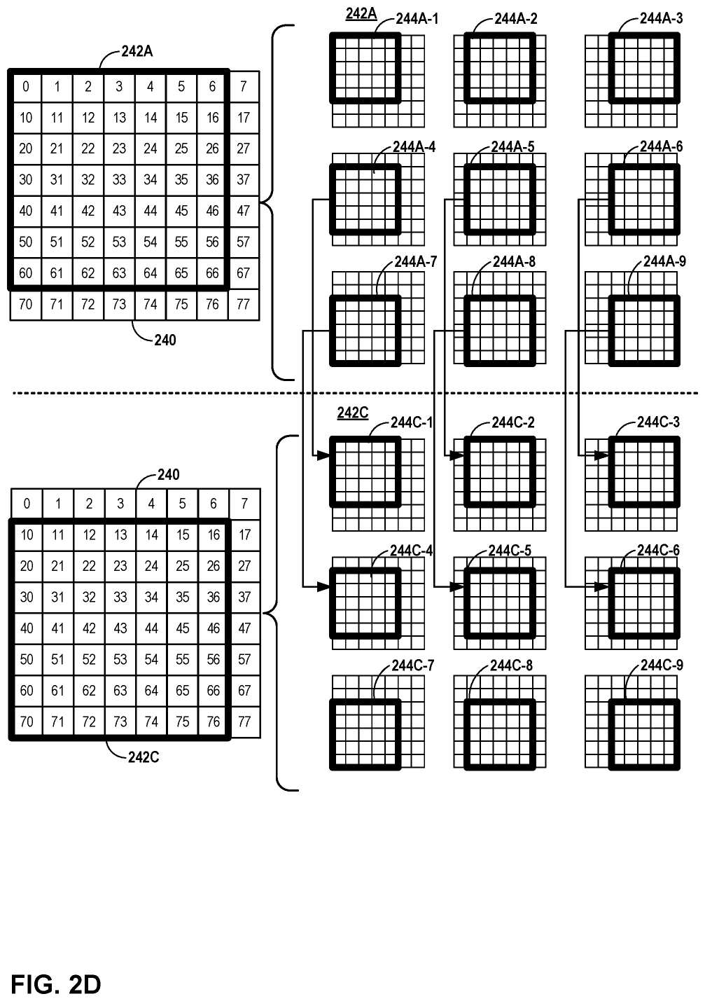

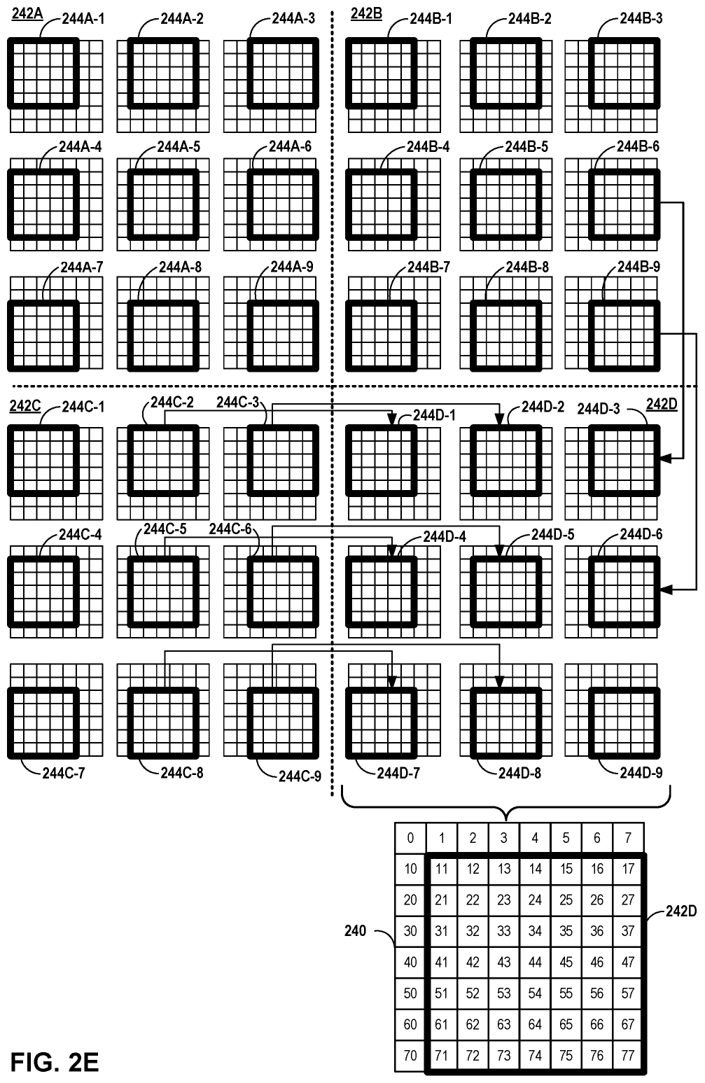

FIGS. 2A-2E are conceptual diagrams illustrating example techniques for performing image filtering operations on kernels of image data. FIGS. 2A-2E are described with respect to FIG. 1.

As shown in FIG. 2A, image data 240 may be at least a portion of an image frame, such as an image frame streamed from camera 102. Image data 240 includes a block of pixels, such as the 9×9 block of pixels shown in FIG. 2A, of an image frame, including padded pixels used by camera processor 104 for performing image filtering operations. The pixels of image data 240 may have a Bayer filter pattern or other color pattern. For example, image data 240 may have alternate rows (e.g., the first row, third row, fifth row, etc.) of pixels having repeated green and red pixels and rows (e.g., the second row, the fourth row, the six row, etc.) of pixels having repeated blue and green pixels. Camera processor 104 may be configured to perform an image filtering operation on kernels 242A-242D (“kernels 242”), which are 7×7 groups of pixels, of image data 240 to perform image processing of image data 240.

For example, camera processor 104 may perform the image filtering operation on kernel 242A, which is a 7×7 block of pixels of image data 240 starting from pixel 0 in the upper-left corner, to generate a filtered value to replace pixel 33, which is the center pixel of kernel 242A, with a filtered value for kernel 242A. Camera processor 104 may perform the image filtering operation on kernels 242B, which is a 7×7 block of pixels of image data 240 starting from pixel 1 in the upper-left corner, to generate a filtered value to replace pixel 34 with a filtered value for kernel 242B. Camera processor 104 may perform the image filtering operation on kernels 242C, which is a 7×7 block of pixels of image data 240 starting from pixel 10 in the upper-left corner, to generate a filtered value to replace pixel 43 with a filtered value for kernel 242C. Camera processor 104 may perform the image filtering operation on kernels 242D, which is a 7×7 block of pixels of image data 240 starting from pixel 11 in the upper-left corner, to generate a filtered value to replace pixel 44 with a filtered value for kernel 242D. While only four 7×7 kernels 242 are illustrated in FIG. 2A, camera processor 104 may perform the image filtering operation on every 7×7 group of pixels in image data 240 to perform image processing of image data 240.

In accordance with aspects of this disclosure, camera processor 104 may be configured to, instead of performing an image filtering operation on an entire kernel, perform the image filtering operation on sub-kernels of the kernel. Camera processor 104 may use the resulting values from performing the image filtering on sub-kernels of the kernel to generate a filtered value that corresponds to the filtered value of the kernel resulting from performing the image filtering operation on the entire kernel.

As shown in FIG. 2B, to determine one or more resulting values from perform an image filtering operation on kernel 242A of image data 240, camera processor 104 may, in place of performing the image filtering operation over the entirety of kernel 242A, perform the image filtering operation on each of sub-kernels 244A-1 to 244A-9 (“sub-kernels 244A”) within kernel 242A of image data 240. While kernel 242A has a size of 7×7 pixels, each of sub-kernels 244A has a size of 5×5 pixels. As such nine sub-kernels 244A are used to cover every 5×5 block of pixels within kernel 242A, and camera processor 104 may perform nine filtering operations on corresponding sub-kernels 244A in place of performing a 2D filter operation on kernel 242A.

When camera processor 104 performs an image processing operation to sub-kernels of neighboring kernels, camera processor 104 may take advantage of overlaps in sub-kernels of neighboring kernels to re-use previously calculated filtered values for overlapping sub-kernels. Re-using previously calculated filtered values for overlapping sub-kernels may reduce the amount of computations performed by camera processor 104 to calculate filtered values for kernels.

As shown in FIG. 2C, kernel 242B is a horizontal neighbor of kernel 242A because kernel 242B is shifted to the right by one pixel in image data 240 compared to kernel 242A. Because kernels 242A and 242B are neighboring kernels, some of the sub-kernels 244A of kernel 242A cover the same pixels in image data 240 as some of the sub-kernels 244B-1 to 244B-9 (“sub-kernels 244B”) of kernel 242B.

Camera processor 104 may, in addition to perform an image filtering operation on sub-kernels 244A of kernel 242A, also perform the same image processing operation to sub-kernels 244B of kernel 242B, which are sub-kernels each having a size of 5×5 pixels. Both sub-kernel 244A-2 and sub-kernel 244B-1 cover the same 5×5 block of pixels starting from pixel 1 in the upper-left corner, while both sub-kernel 244A-3 and sub-kernel 244B-2 cover the same 5×5 block of pixels starting from pixel 2 in the upper-left corner. In another example, both sub-kernel 244A-5 and sub-kernel 244B-4 cover the same 5×5 block of pixels starting from pixel 11 in the upper-left corner, while both sub-kernel 244A-6 and sub-kernel 244B-5 cover the same 5×5 block of pixels starting from pixel 12 in the upper-left corner. Similarly, both sub-kernel 244A-8 and sub-kernel 244B-7 cover the same 5×5 block of pixels starting from pixel 21 in the upper-left corner, while both sub-kernel 244A-9 and sub-kernel 244B-8 cover the 5×5 block of pixels starting from pixel 22 in the upper-left corner.

Performing the same image processing operation on sub-kernels that cover the same block of pixels in image data 240 results in the same filtered values. For example, performing the same image processing operation on sub-kernel 244A-2 and sub-kernel 244B-1 may result in the same filtered values for sub-kernel 244A-2 and sub-kernel 244B-1, performing the same image processing operation on sub-kernel 244A-3 and sub-kernel 244B-2 may result in the same filtered values for sub-kernel 244A-3 and sub-kernel 244B-2, and so on.

Because camera processor 104 may have already performing the same image processing operation on each of sub-kernels 244A-2, 244A-3, 244A-5, 244A-6, 244A-8, and 244A-9 to calculate filtered values for those sub-kernels, camera processor 104 may refrain from performing the same image processing operation on any of sub-kernels 244B-1, 244B-2, 244B-4, 244B-5, 244B-7, and 244B-8 to calculate filtered values for those sub-kernels. Instead, camera processor 104 may buffer the determined filtered values for sub-kernels 244A-2, 244A-3, 244A-5, 244A-6, 244A-8, and 244A-9 of kernel 242A and may use those filtered values as the filtered values for corresponding sub-kernels 244B-1, 244B-2, 244B-4, 244B-5, 244B-7, and 244B-8 of kernel 242B. That is, camera processor 104 may determine the filtered values for sub-kernels 244A-2, 244A-3, 244A-5, 244A-6, 244A-8, and 244A-9 of kernel 242A to be the already determined filtered values for corresponding sub-kernels 244B-1, 244B-2, 244B-4, 244B-5, 244B-7, and 244B-8 of kernel 242B, respectively.

As such, in order to determined filtered values for sub-kernels 244B of kernel 242B, camera processor 104 may only have to perform the image processing operation to three sub-kernels: sub-kernels 244B-3, 244B-6, and 244B-9 to calculate the filtered values for those three sub-kernels. For the remaining sub-kernels 244B, camera processor 104 may use the filtered value for sub-kernel 244A-2 as the filtered value for sub-kernel 244B-1, use the filtered value for sub-kernel 244A-3 as the filtered value for sub-kernel 244B-2, use the filtered value for sub-kernel 244A-5 as the filtered value for sub-kernel 244B-4, use the filtered value for sub-kernel 244A-6 as the filtered value for sub-kernel 244B-5, use the filtered value for sub-kernel 244A-8 as the filtered value for sub-kernel 244B-7, and use the filtered value for sub-kernel 244A-9 as the filtered value for sub-kernel 244B-8. In this way, the techniques of this disclosure may reduce the amount of computation that camera processor 104 performs to calculate the filtered value for kernel 242B by 66% because camera processor 104 may only have to perform the image processing operation on three of the nine sub-kernels 244B of kernel 242B.

As shown in FIG. 2D, kernel 242C is a vertical neighbor of kernel 242A because kernel 242C is shifted downwards by one pixel in image data 240 compared to kernel 242A. Because kernels 242A and 242C are neighboring kernels, some of the sub-kernels 244A of kernel 242A cover the same pixels in image data 240 as some of the sub-kernels 244C-1 to 244C-9 (“sub-kernels 244C”) of kernel 242C.

Camera processor 104 may, in addition to performing an image filtering operation on sub-kernels 244A of kernel 242A, also perform an image filtering operation on sub-kernels 244C of kernel 242C, which are sub-kernels each having a size of 5×5 pixels. Both sub-kernel 244A-4 and sub-kernel 244C-1 cover the same 5×5 block of pixels starting from pixel 10 in the upper-left corner, while both sub-kernel 244A-7 and sub-kernel 244C-4 cover the same 5×5 block of pixels starting from pixel 20 in the upper-left corner. In another example, both sub-kernel 244A-5 and sub-kernel 244C-2 cover the same 5×5 block of pixels starting from pixel 11 in the upper-left corner, while both sub-kernel 244A-8 and sub-kernel 244C-5 cover the same 5×5 block of pixels starting from pixel 21 in the upper-left corner. Similarly, both sub-kernel 244A-6 and sub-kernel 244C-3 cover the same 5×5 block of pixels starting from pixel 12 in the upper-left corner, while both sub-kernel 244A-9 and sub-kernel 244C-6 cover the 5×5 block of pixels starting from pixel 22 in the upper-left corner.

Performing the same image filtering operation sub-kernels that cover the same block of pixels in image data 240 results in the same filtered values. For example, performing the same image filtering operation on sub-kernel 244A-4 and sub-kernel 244C-1 may result in the same filtered values for sub-kernel 244A-4 and sub-kernel 244C-1, performing the same image filtering operation on sub-kernel 244A-7 and sub-kernel 244C-4 may result in the same filtered values for sub-kernel 244A-7 and sub-kernel 244C-4, and so on.

Because camera processor 104 may have already performed the same image filtering operation on each of sub-kernels 244A-4 to 244A-9 to calculate filtered values for those sub-kernels, camera processor 104 may refrain from perform an image filtering operation on any of sub-kernels 244C-1 to 244C-6 to calculate filtered values for those sub-kernels. Instead, camera processor 104 may buffer the filtered values for sub-kernels 244A-4 to 244A-9 and may use those filtered values as the filtered values for corresponding sub-kernels 244C-1 to 244C-6.

As such, in order to determined filtered values for sub-kernels 244C, camera processor 104 may only have to perform the image filtering operation on three sub-kernels: sub-kernels 244C-7, 244C-8, and 244C-9 to calculate the filtered values for those three sub-kernels. For the remaining sub-kernels 244C, camera processor 104 may use the filtered value for sub-kernel 244A-4 as the filtered value for sub-kernel 244C-1, use the filtered value for sub-kernel 244A-5 as the filtered value for sub-kernel 244C-2, use the filtered value for sub-kernel 244A-6 as the filtered value for sub-kernel 244C-3, use the filtered value for sub-kernel 244A-7 as the filtered value for sub-kernel 244C-4, use the filtered value for sub-kernel 244A-8 as the filtered value for sub-kernel 244C-5, and use the filtered value for sub-kernel 244A-9 as the filtered value for sub-kernel 244C-6. In this way, the techniques of this disclosure may reduce the amount of computation that camera processor 104 performs to calculate the filtered value for kernel 242C by 66% because camera processor 104 may only have to perform the image processing operation on three of the nine sub-kernels 244C of kernel 242C.

In some examples, a kernel may have both a horizontal neighboring kernel and a vertical neighboring kernel. Camera processor 104 may take advantage of both the horizontal neighboring kernel and the vertical neighboring kernel to further reduce the amount of computation that camera processor 104 performs to calculate the filtered value for the kernel.

As shown in FIG. 2E, kernel 242D is a vertical neighbor of kernel 242B because kernel 242D is shifted downwards by one pixel in image data 240 compared to kernel 242A. Because kernels 242B and 242D are neighboring kernels, some of the sub-kernels 244B of kernel 242B cover the same pixels in image data 240 as some of the sub-kernels 244D-1 to 244D-9 (“sub-kernels 244D”) of kernel 242D.

Kernel 242D is also a horizontal neighbor of kernel 242C because kernel 242D is shifted to the right by one pixel in image data 240 compared to kernel 242C. As such, some of the sub-kernels 244C of kernel 242C also cover the same pixels in image data 240 as some of sub-kernels 244D of kernel 242D.

Specifically, sub-kernels 244C-2, 244C-3, 244C-5, 244C-6, 244C-8, and 244C-9 of kernel 242C cover the same pixels in image data 240 as sub-kernels 244D-1, 244D-2, 244D-4, 244D-5, 244D-7, and 244D-8, respectively, of kernel 242D. Similarly, sub-kernels 244B-6 and 244B-9 of kernel 242B cover the same pixels in image data 240 as sub-kernels 244D-3 and 244D-6, respectively, of kernel 242D. As such, eight of the nine sub-kernels 244 of kernel 242D cover the same pixels as sub-kernels 244B of kernel 242B and sub-kernels 244C of kernel 242C.

Thus, in order to determined filtered values for sub-kernels 244D, camera processor 104 may only have to perform the image filtering operation on sub-kernel 244D-9 to calculate the filtered value for sub-kernel 244D-9, and may be able to use the filter values for corresponding sub-kernels 244B and 244C that cover the same pixels as the remaining sub-kernels 244D-1 to 244D-8 as the filtered values for the remaining sub-kernels 244D-1 to 244D-8.

For example, camera processor 104 may use the filtered values for the column of sub-kernels 244C-2, 244C-5, and 244C-8 from kernel 242C as the filtered values for the column of sub-kernels 244D-1, 244D-4, and 244D-7, respectively, for kernel 242D. Camera processor 104 may similarly use the filtered values for the column of sub-kernels 244C-3, 244C-6, and 244C-9 from kernel 242C as the filtered values for the column of sub-kernels 244D-2, 244D-5, and 244D-8, respectively, for kernel 242D. Camera processor 104 may also use the filtered values for sub-kernels 244B-6 and 244B-9 from kernel 242B as the filtered values for sub-kernels 244D-3 and 244D-6, respectively, for kernel 242D. In this way, the techniques of this disclosure may reduce the amount of computation that camera processor 104 performs to calculate the filtered value for kernel 242D by 89% because camera processor 104 may only have to perform the image processing operation on a single sub-kernel 244D-9 out of the nine sub-kernels 244D for kernel 242D.

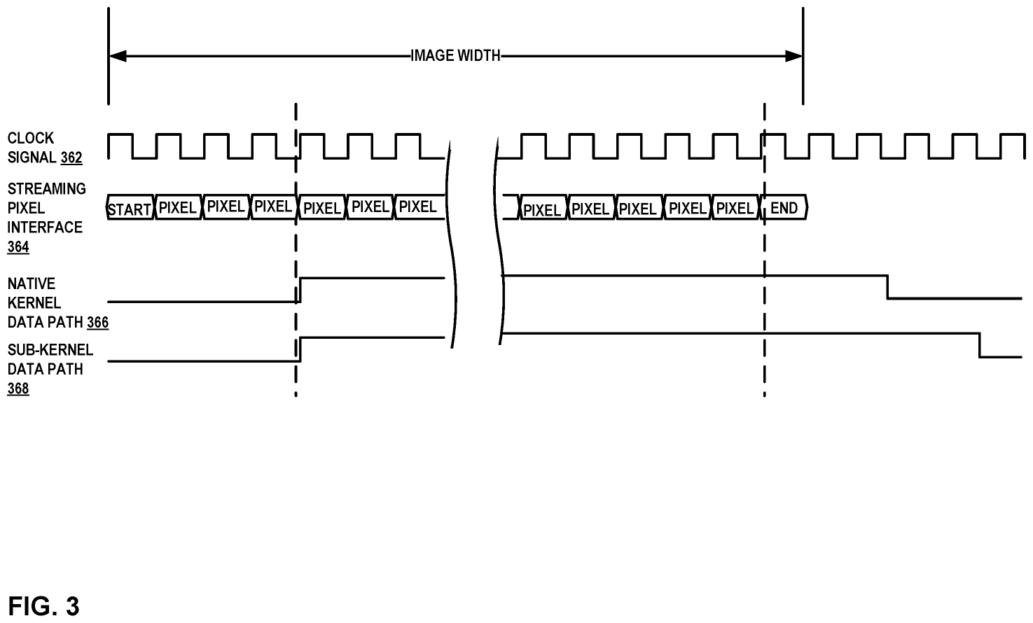

FIG. 3 illustrates a timing diagram that compares applying a filter to a kernel of image data to applying the filter to sub-kernels of the kernel. For example, the timing diagram illustrates perform an image filtering operation on a 7×7 kernel against applying the 2D filter to 5×5 sub-kernels of the 7×7 kernel. FIG. 3 is described with respect to FIG. 1 and FIGS. 2A-2E.

As shown in FIG. 3, clock signal 362 may be configured to govern the processing of image data (e.g., image frames) by camera processor 104. Streaming pixel interface 364 may be a component of processing device that is configured to stream pixels of image data in raster scan order, such as from camera 102 or from local memory 120 or system memory 130, for processing by camera processor 104. Streaming pixel interface 364 may be a component within camera 102, camera processor 104, CPU 106, and/or GPU 108, or may be other circuitry in processing device 100.

Native kernel data path 366 may be a collection of circuitry and/or functional units of camera processor 104 that is configured to perform an image filtering operation on kernels of image data, such as 7×7 kernels, to generate filtered values for the kernels. Native kernel data path 366 may accumulate a number of pixels streamed by streaming pixel interface 364 for padding purposes prior to performing an image filtering operation on a kernel of image data. As can be seen, because native kernel data path 366 delays its performance of the filtering operation to accumulate pixels, native kernel data path 366 may finish performing the filtering operation after streaming pixel interface 364 has stopped streaming pixels of the image data.

Similarly, sub-kernel data path 368 may be a collection of circuitry and/or functional units of camera processor 104 that is configured to perform an image filtering operation on sub-kernels, such as 5×5 sub-kernels, of kernels of image data, such as 7×7 kernels, to generate filtered values for the sub-kernels. Sub-kernel data path 368 may therefore generate filtered values for the kernels based on the filtered values for corresponding sub-kernels of the kernels.

In the example where sub-kernel data path 368 applies a filter to nine 5×5 sub-kernels of a 7×7 kernel, sub-kernel data path 368 may include three data paths that enables sub-kernel data path 368 to calculate filtered values of three sub-kernels at a time. Sub-kernel data path 368 may accumulate a number of pixels streamed by streaming pixel interface 364 for padding purposes prior to performing image filtering operations on sub-kernels of image data. As can be seen, because sub-kernel data path 368 delays its performance of the image filtering operations to accumulate pixels, sub-kernel data path 368 may finish performing the image filtering operations after streaming pixel interface 364 has stopped streaming pixels of the image data. Further, because sub-kernel data path 368 may calculate filtered values for three sub-kernels at a time, sub-kernel data path 368 may also use additional clock cycles (e.g., two extra clock cycles) compared with native kernel data path 366 to calculate filtered values for all nine 5×5 sub-kernels of a 7×7 kernel.

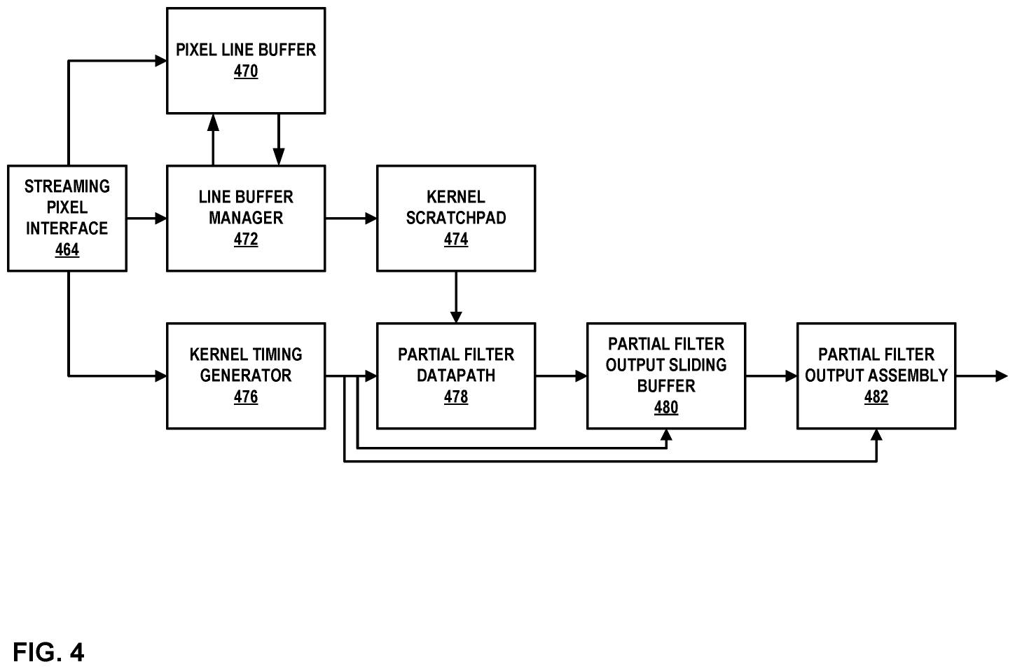

FIG. 4 is a block diagram illustrating a camera processor that takes advantage of horizontal neighboring kernels to reduce computation of sub-kernel filtered values, in accordance with aspects of this disclosure. FIG. 4 is described with respect to FIG. 1 and FIGS. 2A-2E.

As shown in FIG. 4, camera processor 404 is an example of camera processor 104 of FIG. 1. Camera processor 404 includes streaming pixel interface 464, pixel line buffer 470, line buffer manager 472, kernel scratchpad 474, kernel timing generator 476, partial filter data path 478, partial filter output sliding buffer 480, and partial filter output assembly 482. In one or more example, streaming pixel interface 464, pixel line buffer 470, line buffer manager 472, kernel scratchpad 474, kernel timing generator 476, partial filter data path 478, partial filter output sliding buffer 480, and/or partial filter output assembly 482 may be fixed-function circuitry and/or programmable circuitry. That is, the example operations of streaming pixel interface 464, pixel line buffer 470, line buffer manager 472, kernel scratchpad 474, kernel timing generator 476, partial filter data path 478, partial filter output sliding buffer 480, and/or partial filter output assembly 482 described in this disclosure may be performed with fixed-function circuitry and/or may be operations defined by software that execute on programmable circuitry. In examples where streaming pixel interface 464, pixel line buffer 470, line buffer manager 472, kernel scratchpad 474, kernel timing generator 476, partial filter data path 478, partial filter output sliding buffer 480, and partial filter output assembly 482 are programmable circuitry, streaming pixel interface 464, pixel line buffer 470, line buffer manager 472, kernel scratchpad 474, kernel timing generator 476, partial filter data path 478, partial filter output sliding buffer 480, and partial filter output assembly 482 may be combined together in any suitable combination.

Streaming pixel interface 464 is an example of streaming pixel interface 364 of FIG. 3 and may be configured to stream pixels of image data, such as from camera 102, to pixel line buffer 470, line buffer manager 472, and kernel timing generator 476. Pixel line buffer 470, line buffer manager 472, and kernel timing generator 476 may each be configured to receive the streams of pixels from streaming pixel interface 464. Pixel line buffer 470 may be configured to buffer pixels of image data from the streaming pixel interface, and line buffer manager 472 may be configured to manage both the pixels received from the streaming pixel interface and the pixels buffered in pixel line buffer 470 to send the pixels to partial filter data path 478. In the example of 7×7 kernels of image data, line buffer manager 472 may, for each kernel, buffer the pixels of the kernel, and line buffer manager 472 may send lines of pixels of the kernel to partial filter data path 478. Kernel scratchpad 474 may be logic to control the sending of pixels from line buffer manager 472 to partial filter data path 478 to compensate for delays in pixels being streamed by streaming pixel interface 464.

Kernel timing generator 476 may be configured to generate timing signals that are used by partial filter data path 478, partial filter output sliding buffer 480, and partial filter output assembly 482. As described above with respect to FIG. 4, kernel timing generator 476 may extend the timing signals for calculating filtered values for sub-kernels to take into account of partial filter data path 478 using extra clock cycles to calculate all of the sub-kernels of a kernel. For example, if partial filter data path 478 can calculate filtered values for three 5×5 sub-kernels at a time, partial filter data path 478 may need an extra two clock cycles to calculate all nine 5×5 sub-kernels of a 7×7 kernel.

Partial filter data path 478 may be configured to receive lines of pixels from line buffer manager 472 and to perform an image filtering operation on each of the sub-kernels of a kernel to calculate filtered values for the sub-kernels of the kernel. In the example of a 7×7 kernel and 5×5 sub-kernels, partial filter data path 478 may calculate filtered values for nine 5×5 sub-kernels for a given 7×7 kernel. For example, partial filter data path 478 may apply the 2D filter to each of the nine 5×5 sub-kernels to generate corresponding filtered values for each of the nine sub-kernels.

Partial filter data path 478 is a partial data path because partial filter data path 478 may not necessarily calculate filtered values for every sub-kernel of a given kernel. Instead, as described with respect to FIG. 2C, if a current kernel is a horizontal neighbor of a neighboring kernel for which partial filter data path 478 has already calculated filtered values for sub-kernels covering the same pixels as sub-kernels of the current kernel, partial filter data path 478 may refrain from calculating filtered values for sub-kernels of the current kernel that cover the same pixels as the sub-kernels of a neighboring kernel having already-calculated filtered values.

For 5×5 sub-kernels of 7×7 kernels, the right two columns of sub-kernels of a first kernel may cover the same pixels as the left two columns of sub-kernels of a second kernel that is a horizontal neighbor to the right of the first kernel. As can be seen in FIG. 2C, the six sub-kernels 244A-2, 244A-3, 244A-5, 244A-6, 244A-8, and 244A-9 in the right two columns of sub-kernels 244A of kernel 242A cover the same pixels as the six sub-kernels 244B-1, 244B-2, 244B-4, 244B-5, 244B-7, and 244B-8, respectively, in the left two columns of sub-kernels 244B of kernel 242B. As such, partial filter data path 478 may only have to calculate filtered values for sub-kernels 244B-3, 244B-6, and 244B-9 in the right column of sub-kernels 244B of kernel 242B

Thus, partial filter data path 478 may determine, for a given kernel, whether the kernel is a left-most kernel in the image data, which means the kernel does not have a horizontally neighboring kernel to the left of the kernel. If partial filter data path 478 determines that the kernel is a left-most kernel in the image data, partial filter data path 478 may calculate filtered values for every sub-kernel of the given kernel. If partial filter data path 478 determines that the kernel is not the left-most kernel in the image data, partial filter data path 478 may only calculate filtered values for the portion of the sub-kernels that do not cover the same pixels as sub-kernels of the given kernel's horizontally neighboring kernel to the left of the kernel.

Partial filter data path 478 may store, in partial filter output sliding buffer 480 for a kernel, the filtered values determined for the sub-kernels of the kernel. Partial filter data path 478 may persist filtered values for sub-kernels of a kernel that are reused as filtered values for sub-kernels of a neighboring kernel. In the example of 7×7 kernels having 5×5 sub-kernels, partial filter output sliding buffer 480 may store the filtered values for sub-kernels of a given kernel by persisting the previously determined filtered values for the two right-most columns of sub-kernels of the horizontally neighboring kernel to the left of the given kernel while receiving from partial filter data path 478 and storing the filtered values for the right-most column of sub-kernels of the given kernel.

In the example of FIG. 2C, after partial filter data path 478 calculates filtered values for sub-kernels 244A of kernel 242A, partial filter data path 478 may store the filtered values for sub-kernels 244A in partial filter data path 478. Partial filter data path 478 may then calculate filtered values for sub-kernels 244B-3, 244B-6, and 244B-9 of sub-kernels 244B and may store the calculated filtered values in partial filter output sliding buffer 480. Because the filtered values for sub-kernels 244A-2, 244A-3, 244A-5, 244A-6, 244A-8, and 244A-9 of kernel 242A may be re-used as the filtered values for sub-kernels 244B-1, 244B-2, 244B-4, 244B-5, 244B-7, and 244B-8 of kernel 242B, partial filter output sliding buffer 480 may persist the filtered values for sub-kernels 244A-2, 244A-3, 244A-5, 244A-6, 244A-8, and 244A-9, so that those filtered values can be used by partial filter output assembly 482 to calculate the filtered value for kernel 242B.

Partial filter output assembly 482 may be configured to retrieve the filtered values for sub-kernels of a kernel from partial filter output sliding buffer 480 and to generate, using the filtered values for sub-kernels of a kernel, the filtered values of the kernel. That is, partial filter output assembly 482 may be able to determine, using the filtered values of sub-kernels of a kernel generated from applying a filter to the sub-kernels, the filtered values resulting from applying the same filter to the kernel.

For example, if the filtered values of the sub-kernels are the result of applying a minimum filter to each of the sub-kernels, partial filter output assembly 284 may determine, using the filtered values of sub-kernels of a kernel, the filtered value of the kernel that corresponds to applying the minimum filter to the kernel. To determine the filtered value that corresponds to applying the minimum filter to the kernel, partial filter output assembly 482 may select the minimum value out of the filtered values of the sub-kernels as the filtered value of the kernel.

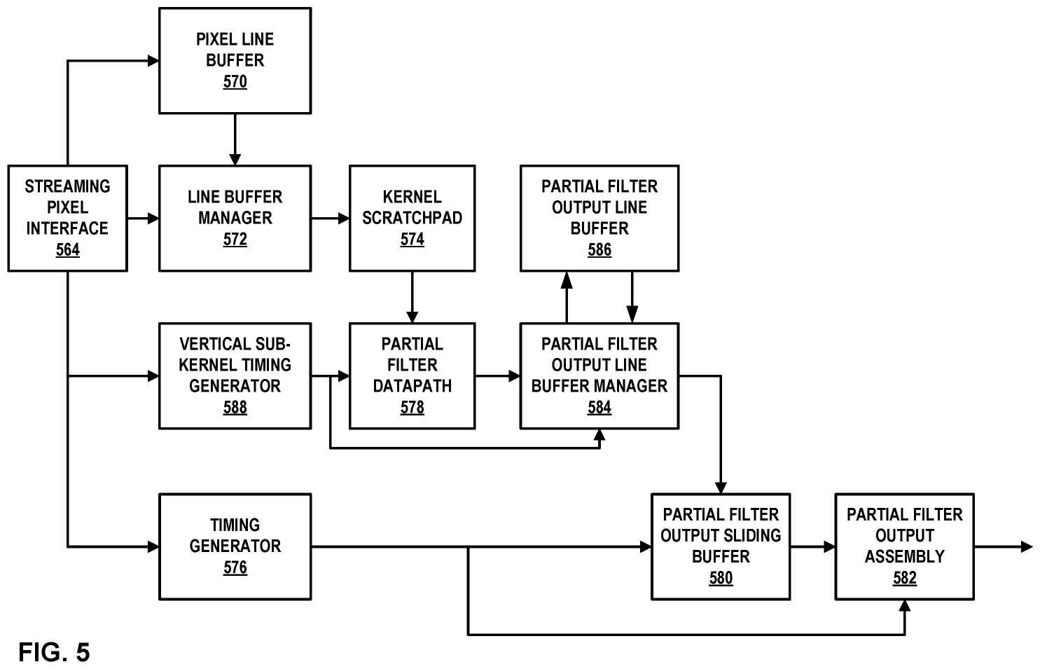

FIG. 5 is a block diagram illustrating a camera processor that takes advantage of horizontal and vertical neighboring kernels to reduce computation of sub-kernel filtered values, in accordance with aspects of this disclosure. FIG. 5 is described with respect to FIG. 1 and FIGS. 2A-2E.

As shown in FIG. 5, camera processor 504 is an example of camera processor 104 of FIG. 1. Camera processor 504 includes streaming pixel interface 564, pixel line buffer 570, line buffer manager 572, kernel scratchpad 574, kernel timing generator 576, partial filter data path 578, partial filter output sliding buffer 580, partial filter output assembly 582, partial filter output line buffer manager 584, partial filter output line buffer 586, and vertical sub-kernel timing generator 588. In one or more example, streaming pixel interface 564, pixel line buffer 570, line buffer manager 572, kernel scratchpad 574, kernel timing generator 576, partial filter data path 578, partial filter output sliding buffer 580, partial filter output assembly 582, partial filter output line buffer manager 584, partial filter output line buffer 586, and/or vertical sub-kernel timing generator 588 may be fixed-function circuitry and/or programmable circuitry. That is, the example operations of streaming pixel interface 564, pixel line buffer 570, line buffer manager 572, kernel scratchpad 574, kernel timing generator 576, partial filter data path 578, partial filter output sliding buffer 580, partial filter output assembly 582, partial filter output line buffer manager 584, partial filter output line buffer 586, and/or vertical sub-kernel timing generator 588 described in this disclosure may be performed with fixed-function circuitry and/or may be operations defined by software that execute on programmable circuitry. In examples where streaming pixel interface 564, pixel line buffer 570, line buffer manager 572, kernel scratchpad 574, kernel timing generator 576, partial filter data path 578, partial filter output sliding buffer 580, partial filter output assembly 582, partial filter output line buffer manager 584, partial filter output line buffer 586, and vertical sub-kernel timing generator 588 are programmable circuitry, streaming pixel interface 564, pixel line buffer 570, line buffer manager 572, kernel scratchpad 574, kernel timing generator 576, partial filter data path 578, partial filter output sliding buffer 580, partial filter output assembly 582, partial filter output line buffer manager 584, partial filter output line buffer 586, and vertical sub-kernel timing generator 588 may be combined together in any suitable combination.

Streaming pixel interface 564 is an example of streaming pixel interface 364 of FIG. 3 and may be configured to stream pixels of image data, such as from camera 102, to pixel line buffer 570, line buffer manager 572, vertical sub-kernel timing generator 588, and kernel timing generator 576. Pixel line buffer 570, line buffer manager 572, vertical sub-kernel timing generator 588, and kernel timing generator 576, are configured to receive streams of pixels from streaming pixel interface 564. Pixel line buffer 570 may be configured to buffer pixels of image data from the streaming pixel interface. Line buffer manager 572 may be configured to manage both the pixels received from the streaming pixel interface and the pixels buffered in pixel line buffer 570, in order to send the pixels to partial filter data path 578. In the example of 7×7 kernels of image data, line buffer manager 572 may, for each kernel, buffer the pixels of the kernel, and line buffer manager 572 may send lines of pixels of the kernel to partial filter data path 578. Kernel scratchpad 574 may be logic to control the sending of pixels from line buffer manager 572 to partial filter data path 578 to compensate for delays in pixels being streamed by streaming pixel interface 564.

Kernel timing generator 576 may be configured to generate timing signals that are used by partial filter output sliding buffer 580, and partial filter output assembly 582. As described above with respect to FIG. 5, kernel timing generator 576 may extend the timing signals for calculating filtered values for sub-kernels to take into account of partial filter data path 578 using extra clock cycles to calculate all of the sub-kernels of a kernel. For example, if partial filter data path 578 can calculate filtered values for three 5×5 sub-kernels at a time, partial filter data path 578 may need an extra two clock cycles to calculate all nine 5×5 sub-kernels of a 7×7 kernel.

Vertical sub-kernel timing generator 588 may be configured to generate timing signals that are used by partial filter data path 578 and partial filter output line buffer manager 584. Vertical sub-kernel timing generator 588 may output timing signals that enable partial filter data path 578 and partial filter output line buffer manager 584 to output filtered values for sub-kernels that take into account of partial filter output assembly 582 being able to reuse filter values for sub-kernels of vertical neighboring and horizontal neighboring kernels.

Partial filter data path 578 may be configured to receive lines of pixels from line buffer manager 572 and to perform an image filtering operation on each of the sub-kernels of a kernel in order to calculate filtered values for the sub-kernels of the kernel. In the example of a 7×7 kernel and 5×5 sub-kernels, partial filter data path 578 may calculate filtered values for nine 5×5 sub-kernels for a given 7×7 kernel. For example, partial filter data path 578 may apply the 2D filter to each of the nine 5×5 sub-kernels to generate corresponding filtered values for each of the nine sub-kernels.

Partial filter data path 578 is a partial data path because partial filter data path 578 may not necessarily calculate filtered values for every sub-kernel of a given kernel. Instead, as described with respect to FIGS. 2C-2E, if a current kernel is a horizontal neighbor and/or a vertical neighbor of one or more neighboring kernels for which partial filter data path 478 has already calculated filtered values for sub-kernels covering the same pixels as sub-kernels of the current kernel, partial filter data path 578 may refrain from calculating filtered values for sub-kernels of the current kernel that cover the same pixels as the sub-kernels of the one or more neighboring kernels having already-calculated filtered values.

In the example of horizontal neighboring kernels, where kernels have a size of 7×7 pixels and sub-kernels have a size of 5×5 pixels, the right two columns of sub-kernels of a left kernel may cover the same pixels as the left two columns of sub-kernels of a right kernel that are horizontal neighboring kernels with each other. As can be seen in FIG. 2C, the six sub-kernels 244A-2, 244A-3, 244A-5, 244A-6, 244A-8, and 244A-9 in the right two columns of sub-kernels 244A of kernel 242A cover the same pixels as the six sub-kernels 244B-1, 244B-2, 244B-4, 244B-5, 244B-7, and 244B-8, respectively, in the left two columns of sub-kernels 244B of kernel 242B. As such, partial filter data path 578 may be configured to only calculate, for kernel 242B, filtered values for sub-kernels 244B-3, 244B-6, and 244B-9 in the right column of sub-kernels 244B.

In the example of vertical neighboring kernels, where kernels have a size of 7×7 pixels and sub-kernels have a size of 5×5 pixels, the bottom two rows of sub-kernels of a top kernel may cover the same pixels as the top two rows of sub-kernels of a bottom kernel that are vertical neighboring kernels with each other. As can been seen in FIG. 2D, the six kernels 244A-4 to 244A-9 in the bottom two rows of sub-kernels 244A of kernel 242A cover the same pixels as the six sub-kernels 244C-1 to 244C-6, respectively, in the top two rows of sub-kernels 244C of kernel 242C. As such, partial filter data path 578 may be configured to only calculate, for kernel 242C, filtered values for sub-kernels 244C-7 to 244C-9 in the bottom row of sub-kernels 244C.

In the example of a kernel having both a horizontal neighboring kernel and a vertical neighboring kernel, a first kernel may have a second kernel as a vertical neighbor above the first kernel and may also have a third kernel as a horizontal neighbor to the left of the first kernel. As can be seen in FIG. 2E, kernel 242D has kernel 242B as a vertical neighboring kernel above kernel 242D, and also has kernel 242C as a horizontal neighboring kernel to the left of kernel 242D. Because kernels 242 are 7×7 kernels having 5×5 sub-kernels, the rightmost two columns of sub-kernels 244C of kernel 242C, including sub-kernels 244C-2, 244C-3, 244C-5, 244C-6, 244C-8, and 244C-9, cover the same pixels as the leftmost two columns of sub-kernels 244D, including sub-kernels 244D-1, 244D-2, 244D-4, 244D-5, 244D-7, and 244D-8, of kernel 242C.

Further, the bottom two columns of sub-kernels 244B of kernel 242B cover the same pixels as the top two columns of sub-kernels 244D of kernel 242D. Thus, sub-kernels 244B-6 and 244B-9 of kernel 242B cover the same pixels as sub-kernels 244D-3 and 244D-6, respectively, of kernel 242D. As such, partial filter data path 578 may be configured to only calculate, for kernel 242D having both a horizontal neighboring kernel 242C and a vertical neighboring kernel 242B, filtered values for a single sub-kernel: sub-kernel 244D-9.

Thus, partial filter data path 578 may be configured to, for a given kernel, only calculate the filtered values of sub-kernels of the kernel that do not cover the same pixel area as a neighboring (e.g., vertical neighboring and/or horizontal neighboring) kernel. For a kernel that does not have a neighboring kernel that is above the kernel and does not have a neighboring kernel to the left of the kernel, such as kernel 242A shown in FIG. 2A, partial filter data path 578 may calculate the filtered values for every sub-kernel for the kernel.

Similarly, for a kernel that has a horizontal neighboring kernel to the left of the kernel but does not have a neighboring kernel that is above the kernel, partial filter data path 578 may calculate the filtered values for sub-kernel of the kernel that do not cover the same pixels covered by sub-kernels of the horizontal neighboring kernel. For a kernel that has a vertical neighboring kernel that is above the kernel but does not have a horizontal neighboring kernel, partial filter data path 578 may calculate the filtered values for sub-kernel of the kernel that do not cover the same pixels covered by sub-kernels of the vertical neighboring kernel. For a kernel that has a horizontal neighboring kernel to the left of the kernel and has a vertical neighboring kernel that is above the kernel, partial filter data path 578 may calculate the filtered values for sub-kernel of the kernel that do not cover the same pixels covered by sub-kernels of the vertical neighboring kernel and do not cover the same pixels covered by sub-kernels of the horizontal neighboring kernel.

Partial filter data path 578 may be configured to send the calculated filtered values of a kernel to partial filter output line buffer manager 584, which may manage the sending of the calculated filter values to partial filter output sliding buffer 580. Partial filter output line buffer manager 584 may be configured to use partial filter output line buffer 586 to buffer the filtered values calculated by partial filter data path 578 in order to manage the sending of the calculated filter values to partial filter output sliding buffer 580.

Partial filter output line buffer manager 584 may be configured to use partial filter output line buffer 586 to buffer filtered values for columns of sub-kernels, which may be reused as filtered values for corresponding sub-kernels of vertical neighboring kernels, as described above. In the example of FIG. 2E where filtered values for sub-kernels 244B-6 and 244B-9 of kernel 242B are also used as the filtered values for sub-kernels 244D-3 and 244D-6, respectively, of kernel 242B, partial filter output line buffer manager 584 may, after calculating filtered values for sub-kernels 244B of kernel 242C and sub-kernels 244C of kernel 242C, buffer the filtered values for sub-kernels 244B-6 and 244B-9 together with the calculated filtered value for sub-kernel 244B-9, which make up the filtered values for the right-most column of sub-kernels 244B, in partial filter output line buffer 586, and may send those three filtered values to partial filter output sliding buffer 580, so that partial filter output sliding buffer 580 may therefore store all nine filtered values of sub-kernels 244D.

Partial filter output sliding buffer 580 may therefore store, for a kernel, the filtered values determined for the sub-kernels of the kernel. Partial filter output sliding buffer 580 may persist filtered values for sub-kernels of a kernel that are reused as filtered values for sub-kernels of a neighboring kernel. In the example of 7×7 kernels having 5×5 sub-kernels, partial filter output sliding buffer 580 may store the filtered values for sub-kernels of a given kernel by persisting the previously determined filtered values for the two right-most columns of sub-kernels of the horizontal neighboring kernel to the left of the given kernel while receiving, from partial filter output line buffer manager 584, the filtered values for the right-most column of sub-kernels of the given kernel.

Partial filter output assembly 582 may retrieve the filtered values for sub-kernels of a kernel from partial filter output sliding buffer 580 and may generate, using the filtered values for sub-kernels of a kernel, the filtered values of the kernel. That is, partial filter output assembly 582 may be able to determine, using the filtered values of sub-kernels of a kernel generated from applying a filter to the sub-kernels, the filtered values resulting from applying the same filter to the kernel.

For example, if the filtered values of the sub-kernels are the result of applying a minimum filter to each of the sub-kernels, partial filter output assembly 582 may determine, using the filtered values of sub-kernels of a kernel, the filtered value of the kernel that corresponds to applying the minimum filter to the kernel. To determine the filtered value that corresponds to applying the minimum filter to the kernel, partial filter output assembly 582 may select the minimum value out of the filtered values of the sub-kernels as the filtered value of the kernel.

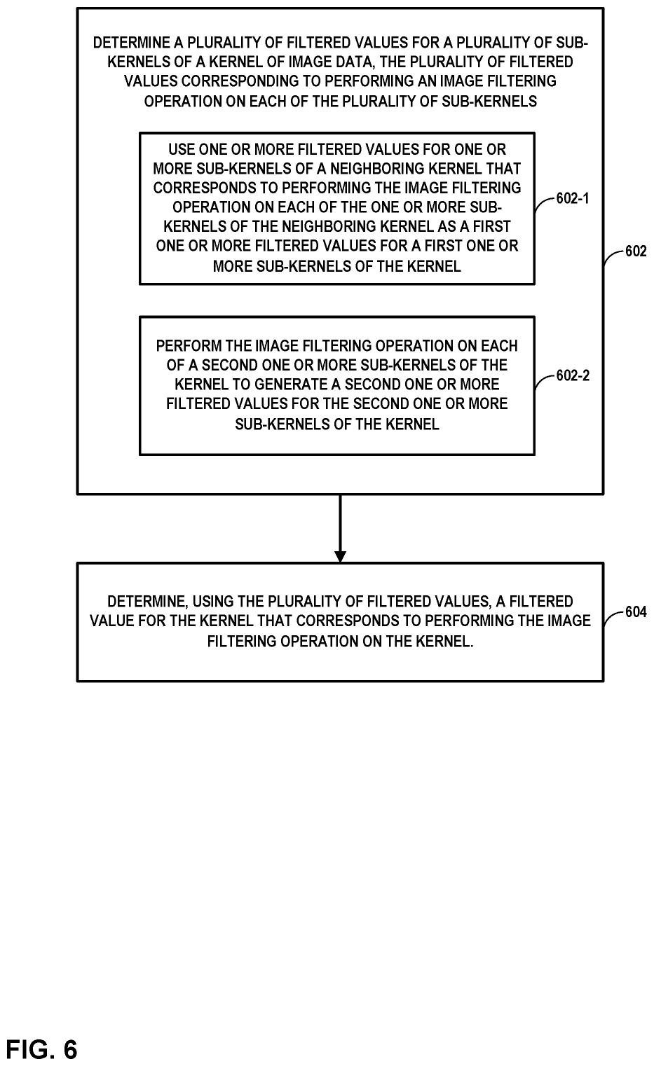

FIG. 6 is a flowchart showing an example method of operation according to the techniques of this disclosure. For ease, the example is described with respect to FIG. 1 and FIGS. 2A-2E.

As shown in FIG. 6, camera processor 104 may determine a plurality of filtered values for a plurality of sub-kernels of a kernel of image data 240, the plurality of filtered values corresponding to performing an image filtering operation on each of the plurality of sub-kernels (602). In some examples, the image filtering operation comprises a neighborhood filtering operation. In some examples, the kernel partially overlaps the neighboring kernel in the image data 240, and where the kernel is one of: shifted to the right by one pixel in the image data 240 compared to the neighboring kernel or shifted down by one pixel in the image data 240 compared to the neighboring kernel.

To determine the plurality of filtered values for the plurality of sub-kernels of the kernel, camera processor 104 may use one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel (602-1).

In some examples, to use the one or more filtered values for the one or more sub-kernels of the neighboring kernel as the first one or more filtered values for the first one or more sub-kernels for the kernel, camera processor 104 may determine, for each respective sub-kernel of the first one or more sub-kernels, the respective sub-kernel as a filtered value for the respective sub-kernel to be a filtered value of a corresponding sub-kernel of the one or more sub-kernels of the neighboring kernel that covers the same pixels in the image data 240 as the respective sub-kernel.

To determine the plurality of filtered values for the plurality of sub-kernels of the kernel, camera processor 104 may also perform the image filtering operation on each of a second one or more sub-kernels of the kernel to generate a second one or more filtered values for the second one or more sub-kernels of the kernel (602-2). Camera processor 104 may determine, using the plurality of filtered values, a filtered value for the kernel that corresponds to performing the image filtering operation on the kernel (604).

In some examples, camera processor 104 may perform the image filtering operation on a plurality of sub-kernels of the neighboring kernel to generate a second plurality of filtered values for the plurality of sub-kernels of the neighboring kernel. Camera processor 104 may determine, using the second plurality of filtered values, a filtered value for the neighboring kernel that corresponds to performing the image filtering operation on the neighboring kernel.

In some examples, the neighboring kernel is a horizontal neighboring kernel to the left of the kernel in the image data 240, and the neighboring kernel partially overlaps the kernel in the image data 240. In some examples, the one or more sub-kernels of the neighboring kernel form one or more right-most columns of sub-kernels of the neighboring kernel, and the first one or more sub-kernels of the kernel forms one or more left-most columns of sub-kernels of the kernel.

In some examples, the neighboring kernel is a vertical neighboring kernel to the top of the kernel in the image data 240, and the neighboring kernel partially overlaps the kernel in the image data 240. In some examples, the one or more sub-kernels of the neighboring kernel form one or more bottom rows of sub-kernels of the neighboring kernel, and the first one or more sub-kernels of the kernel forms one or more top rows of sub-kernels of the kernel.

In some examples to determine the plurality of filtered values for the plurality of sub-kernels of a kernel of image data, camera processor 104 may determine a third one or more filtered values for a third one or more sub-kernels of the kernel to be one or more filtered values for one or more sub-kernels of a second neighboring kernel that corresponds to performing the image filtering operation on each of the one or more sub-kernels of the second neighboring kernel, where the neighboring kernel is a horizontal neighboring kernel, and where the second neighboring kernel is a vertical neighboring kernel.

The following describes other example aspects of the disclosure. The techniques of the following aspects may be used separately or in any combination.

Clause 1. A computing device for image processing, the computing device comprising: a memory; and one or more processors implemented in circuitry, coupled to the memory, and configured to: determine a plurality of filtered values for a plurality of sub-kernels of a kernel of image data, the plurality of filter values corresponding to performing an image filtering operation on each of the plurality of sub-kernels, including: using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing the image filtering operation on each of a second one or more sub-kernels of the kernel to generate a second one or more filtered values for the second one or more sub-kernels of the kernel; and determine, using the plurality of filtered values, a filtered value for the kernel that corresponds to performing the image filtering operation on the kernel.

Clause 2. The computing device of clause 1, wherein to use the one or more filtered values for the one or more sub-kernels of the neighboring kernel as the first one or more filtered values for the first one or more sub-kernels for the kernel, the one or more processors are further configured to: determine, for each respective sub-kernel of the first one or more sub-kernels, a filtered value for the respective sub-kernel as a filtered value of a corresponding sub-kernel of the one or more sub-kernels of the neighboring kernel that covers the same pixels in the image data as the respective sub-kernel.

Clause 3. The computing device of any of clauses 1 and 2, wherein the kernel partially overlaps the neighboring kernel in the image data, and wherein the kernel is one of: shifted to the right by one pixel in the image data compared to the neighboring kernel or shifted down by one pixel in the image data compared to the neighboring kernel.

Clause 4. The computing device of any of clauses 1-3, wherein the image filtering operation comprises a neighborhood filtering operation.

Clause 5. The computing device of any of clauses 1-4, wherein the one or more processors are further configured to: perform the image filtering operation on a plurality of sub-kernels of the neighboring kernel to generate a second plurality of filtered values for the plurality of sub-kernels of the neighboring kernel; and determine, using the second plurality of filtered values, a filtered value for the neighboring kernel that corresponds to performing the image filtering operation on the neighboring kernel.

Clause 6. The computing device of any of clauses 1-5, wherein the neighboring kernel is a horizontal neighboring kernel to the left of the kernel in the image data, and wherein the neighboring kernel partially overlaps the kernel in the image data.

Clause 7. The computing device of clause 6, wherein the one or more sub-kernels of the neighboring kernel form one or more right-most columns of sub-kernels of the neighboring kernel, and wherein the first one or more sub-kernels of the kernel forms one or more left-most columns of sub-kernels of the kernel.

Clause 8. The computing device of any of clauses 1-5, wherein the neighboring kernel is a vertical neighboring kernel to the top of the kernel in the image data, and wherein the neighboring kernel partially overlaps the kernel in the image data.

Clause 9. The computing device of clause 8, wherein the one or more sub-kernels of the neighboring kernel form one or more bottom rows of sub-kernels of the neighboring kernel, and wherein the first one or more sub-kernels of the kernel forms one or more top rows of sub-kernels of the kernel.

Clause 10. The computing device of any of clauses 1-5, wherein to determine the plurality of filtered values for the plurality of sub-kernels of a kernel of image data, the one or more processors are further configured to: determine a third one or more filtered values for a third one or more sub-kernels of the kernel as one or more filtered values for one or more sub-kernels of a second neighboring kernel that corresponds to performing the image filtering operation on each of the one or more sub-kernels of the second neighboring kernel, wherein the neighboring kernel is a horizontal neighboring kernel, and wherein the second neighboring kernel is a vertical neighboring kernel.

Clause 11. The computing device of clause 10, wherein the one or more sub-kernels of the neighboring kernel form one or more right-most columns of sub-kernels of the neighboring kernel, wherein the first one or more sub-kernels of the kernel forms one or more left-most columns of sub-kernels of the kernel, wherein the one or more sub-kernels of the second neighboring kernel are in a right-most column of sub-kernels of the second neighboring kernel, and wherein the third one or more sub-kernels of the kernel are in a right-most columns of sub-kernels of the kernel.

Clause 12. A method of image processing, the method comprising: determining, with one or more processors, a plurality of filtered values for a plurality of sub-kernels of a kernel of image data, the plurality of filtered values corresponding to performing an image filtering operation on each of the plurality of sub-kernels, including: using, with the one or more processors, one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing, with the one or more processors, the image filtering operation on each of a second one or more sub-kernels of the kernel to generate a second one or more filtered values for the second one or more sub-kernels of the kernel; and determining, with the one or more processors and using the plurality of filtered values, a filtered value for the kernel that corresponds to performing the image filtering operation on the kernel.

Clause 13. The method of clause 12, wherein using the one or more filtered values for the one or more sub-kernels of the neighboring kernel as the first one or more filtered values for the first one or more sub-kernels for the kernel further comprises: determining, with the one or more processors and for each respective sub-kernel of the first one or more sub-kernels, that a filtered value for the respective sub-kernel is a filtered value of a corresponding sub-kernel of the one or more sub-kernels of the neighboring kernel that covers the same pixels in the image data as the respective sub-kernel.

Clause 14. The method of any of clauses 12 and 13, wherein the neighboring kernel is a horizontal neighboring kernel to the left of the kernel in the image data, and wherein the neighboring kernel partially overlaps the kernel in the image data.

Clause 15. The method of any of clauses 12-14, wherein the one or more sub-kernels of the neighboring kernel form one or more right-most columns of sub-kernels of the neighboring kernel, and wherein the first one or more sub-kernels of the kernel forms one or more left-most columns of sub-kernels of the kernel.

Clause 16. The method any of clauses 12-14, wherein the neighboring kernel is a vertical neighboring kernel to the top of the kernel in the image data, and wherein the neighboring kernel partially overlaps the kernel in the image data.

Clause 17. The method of clause 16, wherein the one or more sub-kernels of the neighboring kernel form one or more bottom rows of sub-kernels of the neighboring kernel, and wherein the first one or more sub-kernels of the kernel forms one or more top rows of sub-kernels of the kernel.

Clause 18. The method any of clauses 12-14, wherein determining the plurality of filtered values for the plurality of sub-kernels of a kernel of image data further comprises: determining, with the one or more processors, a third one or more filtered values for a third one or more sub-kernels of the kernel as one or more filtered values for one or more sub-kernels of a second neighboring kernel that corresponds to performing the image filtering operation on each of the one or more sub-kernels of the second neighboring kernel, wherein the neighboring kernel is a horizontal neighboring kernel, and wherein the second neighboring kernel is a vertical neighboring kernel.

Clause 19. The method of clause 18, wherein the one or more sub-kernels of the neighboring kernel form one or more right-most columns of sub-kernels of the neighboring kernel, wherein the first one or more sub-kernels of the kernel forms one or more left-most columns of sub-kernels of the kernel, wherein the one or more sub-kernels of the second neighboring kernel are in a right-most column of sub-kernels of the second neighboring kernel, and wherein the third one or more sub-kernels of the kernel are in a right-most columns of sub-kernels of the kernel.

Clause 20. A computer-readable storage medium storing instructions thereon that when executed cause one or more processors to: determine a plurality of filtered values for a plurality of sub-kernels of a kernel of image data, the plurality of filtered values corresponding to performing an image filtering operation on each of the plurality of sub-kernels, including: using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and performing the image filtering operation on each of a second one or more sub-kernels of the kernel to generate a second one or more filtered values for the second one or more sub-kernels of the kernel; and determine, using the plurality of filtered values, a filtered value for the kernel that corresponds to performing the image filtering operation on the kernel.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A computing device for image processing, the computing device comprising:
a memory; and
one or more processors implemented in circuitry, coupled to the memory, and configured to:
determine a plurality of filtered values for a plurality of sub-kernels of a kernel of image data, the plurality of filter values corresponding to performing an image filtering operation on each of the plurality of sub-kernels, including:
using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and
performing the image filtering operation on each of a second one or more sub-kernels of the kernel to generate a second one or more filtered values for the second one or more sub-kernels of the kernel; and
determine, using the plurality of filtered values, a filtered value for the kernel that corresponds to performing the image filtering operation on the kernel.

2. The computing device of claim 1, wherein to use the one or more filtered values for the one or more sub-kernels of the neighboring kernel as the first one or more filtered values for the first one or more sub-kernels for the kernel, the one or more processors are further configured to:
determine, for each respective sub-kernel of the first one or more sub-kernels, a filtered value for the respective sub-kernel as a filtered value of a corresponding sub-kernel of the one or more sub-kernels of the neighboring kernel that covers the same pixels in the image data as the respective sub-kernel.

3. The computing device of claim 1, wherein the kernel partially overlaps the neighboring kernel in the image data, and wherein the kernel is one of: shifted to the right by one pixel in the image data compared to the neighboring kernel or shifted down by one pixel in the image data compared to the neighboring kernel.

4. The computing device of claim 1, wherein the image filtering operation comprises a neighborhood filtering operation.

5. The computing device of claim 1, wherein the one or more processors are further configured to:
perform the image filtering operation on a plurality of sub-kernels of the neighboring kernel to generate a second plurality of filtered values for the plurality of sub-kernels of the neighboring kernel; and
determine, using the second plurality of filtered values, a filtered value for the neighboring kernel that corresponds to performing the image filtering operation on the neighboring kernel.

6. The computing device of claim 1, wherein the neighboring kernel is a horizontal neighboring kernel to the left of the kernel in the image data, and wherein the neighboring kernel partially overlaps the kernel in the image data.

7. The computing device of claim 6,
wherein the one or more sub-kernels of the neighboring kernel form one or more right-most columns of sub-kernels of the neighboring kernel, and
wherein the first one or more sub-kernels of the kernel forms one or more left-most columns of sub-kernels of the kernel.

8. The computing device of claim 1, wherein the neighboring kernel is a vertical neighboring kernel to the top of the kernel in the image data, and wherein the neighboring kernel partially overlaps the kernel in the image data.

9. The computing device of claim 8,
wherein the one or more sub-kernels of the neighboring kernel form one or more bottom rows of sub-kernels of the neighboring kernel, and
wherein the first one or more sub-kernels of the kernel forms one or more top rows of sub-kernels of the kernel.

10. The computing device of claim 1, wherein to determine the plurality of filtered values for the plurality of sub-kernels of a kernel of image data, the one or more processors are further configured to:
determine a third one or more filtered values for a third one or more sub-kernels of the kernel as one or more filtered values for one or more sub-kernels of a second neighboring kernel that corresponds to performing the image filtering operation on each of the one or more sub-kernels of the second neighboring kernel, wherein the neighboring kernel is a horizontal neighboring kernel, and wherein the second neighboring kernel is a vertical neighboring kernel.

11. The computing device of claim 10,
wherein the one or more sub-kernels of the neighboring kernel form one or more right-most columns of sub-kernels of the neighboring kernel,
wherein the first one or more sub-kernels of the kernel forms one or more left-most columns of sub-kernels of the kernel,
wherein the one or more sub-kernels of the second neighboring kernel are in a right-most column of sub-kernels of the second neighboring kernel, and
wherein the third one or more sub-kernels of the kernel are in a right-most columns of sub-kernels of the kernel.

12. A method of image processing, the method comprising:
determining, with one or more processors, a plurality of filtered values for a plurality of sub-kernels of a kernel of image data, the plurality of filtered values corresponding to performing an image filtering operation on each of the plurality of sub-kernels, including:
using, with the one or more processors, one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and
performing, with the one or more processors, the image filtering operation on each of a second one or more sub-kernels of the kernel to generate a second one or more filtered values for the second one or more sub-kernels of the kernel; and
determining, with the one or more processors and using the plurality of filtered values, a filtered value for the kernel that corresponds to performing the image filtering operation on the kernel.

13. The method of claim 12, wherein using the one or more filtered values for the one or more sub-kernels of the neighboring kernel as the first one or more filtered values for the first one or more sub-kernels for the kernel further comprises:
determining, with the one or more processors and for each respective sub-kernel of the first one or more sub-kernels, that a filtered value for the respective sub-kernel is a filtered value of a corresponding sub-kernel of the one or more sub-kernels of the neighboring kernel that covers the same pixels in the image data as the respective sub-kernel.

14. The method of claim 12, wherein the neighboring kernel is a horizontal neighboring kernel to the left of the kernel in the image data, and wherein the neighboring kernel partially overlaps the kernel in the image data.

15. The method of claim 14,
wherein the one or more sub-kernels of the neighboring kernel form one or more right-most columns of sub-kernels of the neighboring kernel, and
wherein the first one or more sub-kernels of the kernel forms one or more left-most columns of sub-kernels of the kernel.

16. The method of claim 12, wherein the neighboring kernel is a vertical neighboring kernel to the top of the kernel in the image data, and wherein the neighboring kernel partially overlaps the kernel in the image data.

17. The method of claim 16,
wherein the one or more sub-kernels of the neighboring kernel form one or more bottom rows of sub-kernels of the neighboring kernel, and
wherein the first one or more sub-kernels of the kernel forms one or more top rows of sub-kernels of the kernel.

18. The method of claim 12, wherein determining the plurality of filtered values for the plurality of sub-kernels of a kernel of image data further comprises:
determining, with the one or more processors, a third one or more filtered values for a third one or more sub-kernels of the kernel as one or more filtered values for one or more sub-kernels of a second neighboring kernel that corresponds to performing the image filtering operation on each of the one or more sub-kernels of the second neighboring kernel, wherein the neighboring kernel is a horizontal neighboring kernel, and wherein the second neighboring kernel is a vertical neighboring kernel.

19. The method of claim 18,
wherein the one or more sub-kernels of the neighboring kernel form one or more right-most columns of sub-kernels of the neighboring kernel,
wherein the first one or more sub-kernels of the kernel forms one or more left-most columns of sub-kernels of the kernel,
wherein the one or more sub-kernels of the second neighboring kernel are in a right-most column of sub-kernels of the second neighboring kernel, and
wherein the third one or more sub-kernels of the kernel are in a right-most columns of sub-kernels of the kernel.

20. A computer-readable storage medium storing instructions thereon that when executed cause one or more processors to:
determine a plurality of filtered values for a plurality of sub-kernels of a kernel of image data, the plurality of filtered values corresponding to performing an image filtering operation on each of the plurality of sub-kernels, including:
using one or more filtered values for one or more sub-kernels of a neighboring kernel that corresponds to performing the image filtering operation on each of the one or more sub-kernels of the neighboring kernel as a first one or more filtered values for a first one or more sub-kernels of the kernel; and
performing the image filtering operation on each of a second one or more sub-kernels of the kernel to generate a second one or more filtered values for the second one or more sub-kernels of the kernel; and
determine, using the plurality of filtered values, a filtered value for the kernel that corresponds to performing the image filtering operation on the kernel.
